(19) United States
(12) Patent Application Publication
(10) Pub. No.: US 2026/0018624 A1
(43) Pub. Date: Jan. 15, 2026

(54) PRODUCTION OF A COMPONENT WITH A GAS-TIGHT ION-CONDUCTING FUNCTIONAL LAYER, AND COMPONENT

(71) Applicant: Forschungszentrum Jülich GmbH, Jülich (DE)

(72) Inventors: Martin Bram, Jülich (DE); Olivier Guillon, Jülich (DE); Moritz Kindelmann, Köln (DE)

(21) Appl. No.: 18/992,968

(22) PCT Filed: Jun. 16, 2023
(86) PCT No.: PCT/EP2023/066224

§ 371 Date: Jan. 9, 2025

(30) Foreign Application Priority Data
Jul. 11, 2022 (DE) 10 2022 207 066.6

(51) Int. Cl. H01M 4/88; B28B 19/00; C04B 35/626; C04B 35/63; C04B 35/645; C04B 37/02

(52) U.S. Cl. CPC H01M 4/881; B28B 19/00; C04B 35/62675; C04B 35/6268; C04B 35/63; C04B 35/645; C04B 37/02; H01M 4/8875; H01M 4/8885; C04B 2235/656

(57) ABSTRACT

The invention relates to a method for producing a component (11) having a gas-tight, ion-conducting ceramic functional layer (9), comprising the steps of:
ceramic powder material is pressed with a sintering additive by a pressing tool (1) at a pressure of at least 50 MPa,
the pressed ceramic powder material and the sintering additive are sintered.

The invention also relates to a component producible with the method.

The invention relates to a method for producing a component with a gas-tight, ion-conducting ceramic functional layer and to a component produced according to the method.

An example of a component with a gas-tight, proton-conducting ceramic functional layer is a fuel cell comprising a ceramic electrolyte material as a proton conductor from anode to cathode. The anode may be located on one side of the electrolyte layer. The cathode may be located on the opposite side of the electrolyte layer.

A fuel cell with a gas-tight, proton-conducting ceramic electrolyte material electrochemically oxidizes fuel, namely hydrogen or hydrocarbons, at the hydrogen electrode. In the case of the fuel cell, the hydrogen electrode is the anode. Gaseous fuels are absorbed on the surface of the hydrogen electrode in the presence of water vapor, wherein carbon dioxide may be the primary reaction product. Hydrogen atoms are converted into H⁺ ions, i.e., protons. The protons pass through the electrolyte and then react with oxygen on the side of the oxygen electrode, which is the cathode in the case of a fuel cell. The reaction produces water, electricity and heat. The heat generated can keep the fuel cell at a suitable operating temperature of 400° C. to 700° C., for example.

The electrolyte material may comprise or consist of a combination of BaZrO₃ and BaCeO₃.

The hydrogen electrode of the fuel cell may consist of a gas-permeable, porous ceramic-metal composite material (so-called cermet) and include a proton-conducting material as the ceramic phase (e.g., BZCY) and nickel as the metallic phase. The conversion of hydrogen atoms into H⁺ ions preferably takes place at the three-phase boundary gas phase—nickel—proton-conducting material. If the proton-conducting material also has electrical conductivity in addition to proton conduction (so-called mixed conduction), the conversion of hydrogen atoms into H⁺ ions can also take place on the surface of the mixed-conducting material, which increases the electrochemical activity of the hydrogen electrode.

The oxygen electrode of the fuel cell may consist of a gas-permeable, porous, mixed-conducting ceramic. One example of this is perovskites based on lanthanum strontium cobalt iron oxide. As an alternative, the possibility consists to manufacture the oxygen electrode of a gas-permeable, porous, two-phase ceramic material, wherein one ceramic phase is proton-conducting and the other ceramic phase is electron-conducting.

The fuel cell described above is also known as a proton-conducting fuel cell (PCFC).

The described electrode-electrolyte unit of a PCFC can also be part of an electrolysis cell, which is then called a proton-conducting electrolysis cell (PCEC).

An electrolysis cell with a gas-tight, proton-conducting ceramic electrolyte material correspondingly works in reverse to generate hydrogen at the hydrogen electrode, which is then the cathode, and oxygen at the oxygen electrode, which is then the anode, from water and an electric current. The operating temperature can then also be 400° C. to 700° C.

For producing such components with a gas-tight, ion-conducting electrolyte, powder-based manufacturing processes such as film casting or screen printing or wet powder spraying are not very suitable, as high processing temperatures of more than 1350° C. or inorganic sintering additives are required to achieve sufficient gas-tightness. High processing temperatures and inorganic sintering additives cause problems that result in unsatisfactory electrochemical properties.

State of the art is N. Sata, F. Han, H. Zheng, A.M. Dayaghi, T. Norby, M. Stange, R. Semerad, R. Costa, Development of Proton Conducting Ceramic Cells in Metal Supported Architecture, ESC Meet. Abstr. MA2021-03 (2021) 95-95; https://doi.org/10.1149/ma2021-03195mtgabs; R. Wang, G. Y. Lau, D. Ding, T. Zhu, M. C. Tucker, Approaches for co-sintering metal-supported proton-conducting solid oxide cells with Ba (Zr,Ce, Y, Yb) O3-d electrolyte, Int J. Hydrogen Energy. 44 (2019) 13768-13776; https://doi.org/10.1016/jijhydene.2019.03.181; G.Y. Lau, M. C. Tucker, Development of Metal-Supported Proton-Conducting Solid Oxide Cells Via Co-Sintering, ECS Meet. Abstr. MA2021-03 (2021) 83-83; https://doi.org/10.1149/ma2021-03183mtgabs; M. C. Tucker, Progress in metal-supported solid oxide electrolysis cells: A review, Int. J Hydrogen Energy. 45 (2020) 24203-24218; https://doi.org/10.1016/j.ijhydene.2020.06.300, CN 103165 930 A and GB 25 24 640 A.

The task of the invention is to be able to produce components with a gas-tight, ion-conducting ceramic functional layer with improved properties. In particular, a production should be possible at a comparatively low sintering temperature. Shrinkage of materials due to thermal treatments should preferably be avoided in order to prevent thermally induced mechanical stresses between the individual layers, which can lead to failure due to cracking or detachment of the layers. Preferably, sintering aids based on inorganic solids should be avoided, since such sintering aids adversely affect electrochemical properties.

The task of the invention is solved by a method having the features of the first claim and by a component having the features of the additional claim. Advantageous embodiments are given in the dependent claims.

To produce a component with a gas-tight, ion-conducting ceramic functional layer, ceramic powder material is pressed together with a sintering additive by a pressing tool in a first step. The pressing pressure is at least 50 MPa and can be at least 100 MPa or at least 200 MPa. The pressed powder material and the sintering additive pressed with it are sintered.

By pressing the ceramic powder material together with the sintering additive, it is achieved that relatively low sintering temperatures are sufficient during subsequent sintering to achieve a high density. The density achieved after pressing with sintering additive may already be sufficient to achieve a sufficiently high gas tightness even without a subsequent sintering step, for example for the operation of a fuel cell or electrolysis cell.

The ceramic powder material for producing proton-conducting electrolytes may comprise BaZrO₃ and/or BaCeO₃ or consist of this combination. By varying the mixing ratio and adding further oxides, the stoichiometry of proton-conducting materials can be varied over a wide range. Alloy systems for metal-supported PCFC/PCEC cells such as BaZr_{1-x-y}CeₓY_{y}O_{3-d} (BZCY), SrZr_{1-x-y}CeₓY_{y}O₃-d (SZCY), and La₁₋ₓCaₓNbO_{4-d} (LCN) with variable x,y values can be used as powder material. d means an optionally introduced sub-stoichiometry of the oxygen atoms in the lattice, which can improve the electrochemical properties. Depending on the sintering additives used, the method can also be applied to other oxide ceramic electrolyte materials such as ZrO₂ doped with Y₂O₃ (YSZ), ZrO₂ doped with Sc₂O₃ (ScSZ), CeO₂ doped with Gd₂O₃ (GDC)). The method can also be used for oxide powder mixtures (e.g., NiO-BZCY, NIO-SZCY, NIO-LCN, NIO-YSZ, NiO-ScSZ, NIO-GDC). Another area of application is mixed conductive gas separation membranes (e.g., La₁₋ₓSrₓCo_{1-y}Fe_{y}O_{3-d} (LSCF), La₁₋ₓSrₓCo_{y}O_{3-d} (LSC), Ba₁₋ₓSrₓCo_{1-y}Fe_{y}O_{3-d} (BSCF), La₁₋ₓSrₓMn_{y}O_{3-d} (LSM). The average grain size of the powder material can be larger than 10 nanometers and/or smaller than 1 micrometer. The particle size distribution can be monomodal with a maximum particle size in the range of 30 nanometers and 800 nanometers. The thickness of the functional layer after sintering can be greater than 2 μm and/or less than 200 μm. Ideally, it should be 5-10 μm. The leakage rate of the functional layer can be below 10⁻³ hPa·dm³·s⁻¹·cm⁻². The leakage rate is determined using the differential pressure test method (see https://www.drwiesner.de/produkte/dichtheitspruefgeraete/integra.html).

Electrodes may be attached to both sides of the functional layer in order to obtain an electrode-electrolyte unit that can be part of a fuel cell or part of an electrolysis cell. At least one electrode is gas-permeable. Preferably, both electrodes are gas-permeable.

In particular, the functional layer is a proton-conducting ceramic.

In one embodiment, a gas-permeable substrate can be brought into the pressing tool. Subsequently, the ceramic powder material and the sintering additive can be brought into the pressing tool, namely onto the gas-permeable substrate. The gas-permeable substrate with the ceramic powder material and the sintering additive on it can then be pressed. Subsequently, sintering can be performed. In this way, a composite for a component can be produced in just a few steps, which comprises the gas-tight, ceramic functional layer and a gas-permeable layer attached to it. A mixed-conductive gas separation membrane can be produced in this way.

In a further embodiment, a gas-permeable, porous electrode can be applied to the gas-permeable substrate. The pore size of the electrode can be smaller than the pore size of the gas-permeable substrate, which facilitates the deposition of the gas-tight functional layer. The gas permeable porous electrode can be produced by methods such as screen printing, spraying, film casting followed by sintering. Alternatively, the possibility persists to use the method described above (pressing the powder with a sintering additive with subsequent sintering at reduced temperature) also for an electrode material. An electrochemical cell can preferably be produced with this embodiment. Applying an additional electrode to the substrate is advantageous for the function of the electrochemical cell if a substrate itself either has no electrochemical properties (this is the case with an electrochemically inert substrate) or has electrochemical properties that are too poor for practical use.

The gas-permeable substrate consists in particular of an electrically conductive material. The gas-tight, ceramic functional layer is in particular electrically non-conductive. Such a component may be part of a fuel cell or an electrolysis cell. The gas-tight, ceramic functional layer may be the electrolyte layer of a fuel cell or an electrolysis cell. The electrically conductive, gas-permeable substrate may be an electrode of the fuel cell or the electrolysis cell.

The gas-permeable substrate may have been produced using powder technology methods and pre-sintered, for example at temperatures of more than 1000° C. and/or less than 1400° C. The gas-permeable substrate may consist of metal. The gas-permeable substrate may therefore be a porous layer consisting of metal. The metal may be a stainless steel. The stainless steel may have a high chromium content. The chromium content may be more than 16% by weight and/or less than 30% by weight. For example, the metal can be an ITM Fe-26% Cr alloy. Other ferritic iron chromium alloys may also be suitable. Other metallic high-temperature alloys such as nickel-based alloys are possible.

Alternatively, the metallic substrate may consist of a sheet metal in which gas-permeable openings are made. The openings can be made mechanically (e.g., punching, drilling or stretching over an edge) or using a laser beam.

The gas-permeable substrate is preferably thicker than the functional layer, before sintering and/or after sintering, in order to achieve high-performance fuel cells or electrolysis cells. The thickness of the gas-permeable substrate may be at least 50 μm and/or not more than 1000 μm. The preferred thickness of the substrate is in the range of 200-300 μm.

Due to the pressing with a sintering additive, sintering temperatures of less than 1400° C. or less than 1350° C. are usually sufficient to obtain a gas-tight, ceramic functional layer that can conduct ions such as protons. In particular, high-temperature alloys can withstand these sintering temperatures. This means that at sintering temperatures of less than 1400° C. or less than 1350° C. or less than 1300° C., metal substrates can be pressed with the ceramic powder material in one step and then sintered.

After pressing and sintering, an electrode may be applied to the ceramic functional layer. The electrode material may be applied by screen printing, film casting or spraying, for example. After applying the electrode material, sintering can be repeated. The re-sintering can advantageously be performed at a temperature that is lower than the temperature that prevailed during the first sintering. The temperature for the re-sintering can be less than 1300° C. and/or more than 600° C.

The electrode material may be an electrically conductive perovskite. The material of the electrode may consist based on the alloy systems La₁₋ₓSrₓCo_{1-y}Fe_{y}O_{3-d} (LSCF), La₁₋ₓSrₓCo_{y}O_{3-d} (LSC), La₁₋ₓSrₓMn_{y}O_{3-d} (LSM) with varying x,y values. Alternatively, the lanthanum in these structures can be replaced by other elements such as samarium, barium or praseodymium. Furthermore, it is possible to add the electrolyte material to the electrode to increase the number of three-phase boundaries in the electrode.

A sintering additive is preferably liquid in order to achieve particularly good results. Preferably, the amount of sintering additive is chosen so that the powder grains are completely covered by the sintering additive. The sintering additive can be adsorbed on the surfaces of the powder grains. There is then at least one monomolecular layer of sintering additive on the surfaces of the powder grains. To ensure this, sintering additive can be added in excess. This is the case if there is more than one monomolecular layer of sintering additive on the powder particles. The amount of sintering additive can be selected such that all pores in the powder material are completely filled with sintering additive. The amount of sintering additive can also be selected such that more sintering additive is added than the pore volume of the powder bed. In this case, some of the sintering additive is pressed out of the pressing tool during pressing. This variant can bring an advantage in the reorientation of the powder particles at the beginning of the pressing process. The sintering additive can be brought into the pressing tool before or after the ceramic powder grains. The sintering additive can be brought into the pressing tool together with the ceramic powder grains. For this purpose, the sintering additive can be homogeneously mixed with the ceramic powder in an external mixing unit.

However, it is also possible to compact dry ceramic powder, for example at a pressure of no more than 400 MPa and/or at a pressure of at least 50 MPa. Liquid sintering additive can then be added. Capillary forces then ensure that the sintering additive is evenly distributed in the layer formed from powder.

The preferred sintering additive is a liquid in which components of the ceramic powder dissolve. One possible sintering additive is water. In order to increase the solubility, the pH value of the sintering additive can be specifically adjusted. Organic solvents can also be used as a sintering additive. Alternatively, ceramic precursors can be used as sintering additives. Ceramic precursors are liquids that are usually used for powder synthesis. Examples include liquid metal nitrates, metal citrate complexes or metal alcoholates. As an alternative to liquid sintering additives, solid powders that include functional groups such as hydroxides, for example, can also be used as sintering additives. Examples are NaOH and KOH powder. The functional groups enable similar densification at moderate temperatures as is achieved when using liquid sintering additives.

Pressing is preferably carried out at temperatures of at least 100 or 200° C. and/or at temperatures of not more than 600° C. or not more than 500° C. or not more than 400° C. The temperature prevailing during pressing is preferably selected such that almost complete compaction of the ceramic functional layer is already achieved. During pressing, the powder material basically shrinks because the particles of the powder material are compacted and pore spaces are filled. The higher the density achieved during pressing with the sintering additive, the lower the shrinkage during the subsequent sintering step, which can be performed at temperatures above 400° C. or above 500° C. or above 600° C. In this way, a component with further improved desired properties can be obtained, especially if a substrate is used that does not exhibit sintering shrinkage at the sintering temperature.

The pressure used for pressing can be up to 600 MPa or up to 500 MPa, for example.

The ceramic powder material is pressed together with the sintering additive in such a way that a density of at least 80%, in one configuration of the invention 90% or 95% or 99% of the theoretical density is achieved. Such results are possible due to the sintering additive at high pressing pressures of at least 50 MPa. Such densities can in principle be achieved even when pressing is carried out at room temperature. If a closed porosity is achieved by pressing, the layer can already achieve the specification for gas tightness after pressing.

In principle, the sintering additive is selected such that it interacts with the ceramic. The sintering additive interacts with the ceramic, for example, if it is suitable to dissolve one or more elements from the ceramic and/or to react with one or more elements of the ceramic.

Following the pressing in an advantageous embodiment of the invention, the pre-compacted layer can be given its final shape by a downstream sintering step at temperatures of, for example, above 600° C. Residues of the sintering additive can thus be removed. In the sintering step, the residues of the sintering additive on the grain boundaries can be removed, whereby the gas tightness and ionic conductivity and thus also the performance of the electrolyte can be improved. The higher the density of the layer after pressing, the lower the resulting sintering shrinkage in the subsequent optional sintering step and the lower the sintering temperature then required to achieve the final shape, if necessary.

Preferably, in one embodiment of the invention, the layer to be sintered is applied to a substrate which shows no or virtually no sintering shrinkage during the sintering step in order to avoid destructive stresses and associated disadvantages. The substrate may consist of metal. The substrate may then serve as an electrode. The substrate may consist of a cermet or a ceramic.

Reducing this sintering shrinkage to a minimum is advantageous if the layer shows no shrinkage or no practically relevant shrinkage. This can be the case, for example, when using metallic substrates. A further advantage of the liquid sintering additive over inorganic sintering additives is the residue-free removal during the sintering step, which avoids undesirable impurities and secondary phases in the electrolyte.

The method can be used to produce a component with a gas-tight, ion-conducting, ceramic functional layer with a leakage rate of less than 10⁻³ hPa·dm³·s⁻¹·cm⁻² and/or with an ion conductivity of more than 10⁻³ S·cm⁻¹ at 600° C. and/or with a sintering additive that is completely removed during the final sintering step. A porous, gas-permeable substrate consisting of metal may be attached to one side of the functional layer. The metal may be selected to withstand sintering temperatures of less than 1350° C. or less than 1300° C. The metal may be a ferritic iron-chromium steel. A chromium content in the steel may be at least 16% by weight and/or not more than 30% by weight.

An economically and technologically attractive design for creating metal-supported, proton-conducting fuel and electrolysis cells can be obtained by the invention. The combination of a functional ceramic layer and a metallic substrate leads to high electrochemical power, mechanical stability with simple joining technology and moderate material costs.

The invention makes it possible to significantly reduce the sintering temperature in order to minimize the risk of interface reactions and interdiffusion processes. The invention makes it possible to produce gas-tight functional layers on porous metallic substrates that no longer exhibit sintering shrinkage during thermal treatment. The invention makes it possible to completely dispense with sintering aids based on inorganic solids such as NiO, ZnO, Co₃O₄, which may lead to a change in the chemical composition of the ceramic functional layers and thus change the functional properties. Disadvantageous diffusion barriers between the metal substrate and the ceramic functional layer can be dispensed with. Such diffusion barriers are therefore basically not present. There are no interdiffusion and processing problems. A high ionic conductivity can be achieved by sintering at comparatively low sintering temperatures. Sintering also ensures that disadvantageous secondary phases, which may still be present after pressing with the sintering additive, are converted or completely removed, so that secondary phases do not adversely affect electrochemical properties.

The sintering additive can be brought into the interior of the pressing tool using a dispensing system. A liquid sintering additive is basically selected for a specific material. A liquid sintering additive fulfills the following tasks during pressing and the associated compaction process: The liquid phase improves the compressibility of the powder, as it reduces the friction between the powder particles as well as the wall friction. The liquid phase modifies the interface between the powder particles, which changes the sintering kinetics in such a way that, when a sufficiently high pressure (usually between 50 and 500 MPa) is applied, almost complete compaction of the powder is achieved at temperatures of less than 600° C. or 500° C. or 400° C. At temperatures of no more than 600° C. or 500° C. or 400° C., the powder can be partially dissolved by the sintering additive. During further processing, the dissolved material is reprecipitated on the grain boundaries. This occurs in particular when the proportion of the liquid phase of the sintering additive decreases with increasing temperature.

A ceramic precursor can be added to the liquid sintering additive in order to enhance the advantageous dissolution/reprecipitation process.

Pores resulting from evaporation/desorption are removed from the functional layer by mechanical pressure. The functional layers produced by such a process are characterized by a very high relative density of more than 90% of the theoretical density, but may still have a residual proportion of the usually amorphous interfacial phase. Through an adapted thermal post-treatment, i.e., sintering, at significantly lower temperatures compared to conventional processes, for example less than 1300° C., amorphous interface phases can be returned to the original phase in order to ensure the full functionality of the functional layer material.

The processing temperature of the ceramic functional layers, and here in particular of the electrolyte, can therefore be significantly lowered compared to methods known from the prior art, so that the energy requirement for heat treatment and thus the emission of greenhouse gases is reduced.

No inorganic, powder-based sintering additives such as NiO, ZnO, CO₃O₄ are required for the compaction of the electrolyte, which make it difficult to produce functional layers in a reproducible manner and can impair the electrochemical properties due to secondary phase formation. The invention enables ceramic functional layers to be compacted to a high density of more than 90% of the theoretical density at temperatures of less than 400° C. In this way, the sintering shrinkage of these layers during subsequent sintering is reduced to a minimum, so that the co-shrinkage of a metal substrate is not necessary to achieve the gas-tightness of ceramic membranes. Furthermore, mechanical stresses induced in the layer composite are avoided. The significant lowering of the processing temperature reduces the occurrence of disadvantageous interdiffusion effects and interfacial reactions. Material combinations and sintering temperatures can be selected in such a way that diffusion barrier layers can be dispensed with. The use of liquid sintering additives, which can optionally also include ceramic precursors, enables high densification (>90%) of ceramic functional layers through a pressure-assisted densification process already at temperatures of less than 400° C. It is possible to produce gas-tight ceramic functional layers on porous substrates. To achieve practically complete gas-tightness, further sintering is performed at higher temperatures. However, the temperature for this sintering is significantly lower than for conventional sintering. Furthermore, co-shrinkage of the substrate during the temperature treatment is no longer absolutely necessary to achieve the gas-tightness of the functional layer. As a further advantage, the use of sintering additives based on inorganic solids can be dispensed with, so that the formation of secondary phases can be reliably avoided.

The invention relates primarily to producing metal-supported, proton-conducting electrochemical cells that can be operated in fuel cell mode and electrolysis mode (so-called proton-conducting fuel cells/proton-conducting electrolysis cells PCFC/PCECs), but can also be transferred to other ceramic functional materials and alternative substrate materials (e.g., all-ceramic layer systems). Depending on this, suitable sintering additives can be selected which cover the surface of the powder particles with at least one monomolecular layer and exhibit dissolution/reprecipitation behavior in contact with the ceramic functional material at temperatures <400° C.

The described advantages of the invention are achieved above all in comparison with the prior art mentioned in the introduction:

In the preferred configuration, the sintering additive is liquid. Alternatively, the sintering additive can also be a suitable powder whose structure includes functional groups that enable compaction at low temperatures. An example of this is metal hydroxide powder (e.g., NaOH or KOH). Pressing with the sintering additive is preferably performed at temperatures of at least 20° C. or at least 300° C. or at least 600° C. The pressing pressure can be applied before or during heating.

The sintering temperature in the sintering step, which is performed after pressing, is preferably selected depending on the ceramic powder material and/or the particle size of the ceramic powder material and/or the impurities of the ceramic powder material and/or the compaction achieved after pressing and/or the sintering atmosphere and/or other sintering parameters such as heating rate, holding time at sintering temperature. The sintering temperature is higher than the temperature used during pressing. The sintering temperature is higher than the subsequent operating temperature of the electrochemical cell if the component serves as an electrochemical cell such as an electrolysis cell or fuel cell. In principle, the sintering temperature can be lowered by at least 100° C. compared to the temperature at which the electrolyte is conventionally sintered.

The invention is also explained in more detail below with reference to figures.

The figures show

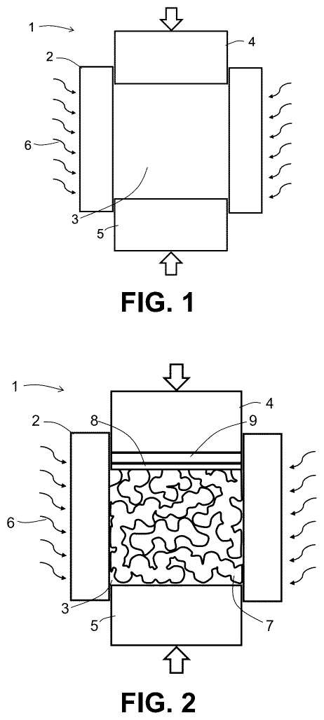

FIG. 1: Pressing tool;

FIG. 2: Pressing tool with substrate and functional therein inside;

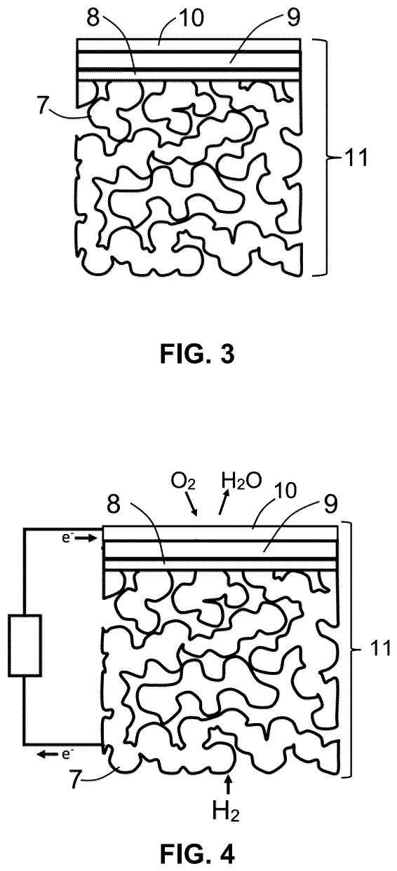

FIG. 3: Electrode-electrolyte unit;

FIG. 4: Fuel cell;

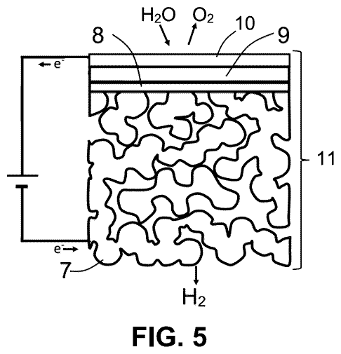

FIG. 5: Electrolysis cell.

FIG. 1 shows a pressing tool 1. The pressing tool 1 comprises side walls 2, which enclose an interior 3. On the upper side there is a pressing plunger 4, which can be moved downwards towards the interior 3 of the pressing tool 1 and back again for pressing, as indicated by an arrow. On the underside there is a base 5, which may also be configured as a movable pressing plunger. If the base 5 is configured as a movable pressing plunger, the base 5 can be moved upwards and thus into the interior 3, as indicated by an arrow, for pressing. The base 5 can then also be moved back again. The pressing tool 1 comprises a heating device 6, with which the interior of the pressing tool 1 can be heated.

To produce an electrode-electrolyte unit, the pressing plunger 4 can first be moved upwards out of the interior 3 such that the interior 3 of the pressing tool 1 is accessible from above. A porous, gas-permeable substrate 7 consisting of metal can be brought into the interior 3 of the pressing tool 1 from above. The substrate 7 can either have electrode properties itself or optionally have a gas-permeable, porous electrode 8 on the upper side with a pore size smaller than the pore size of the substrate 7. The gas-permeable, porous electrode 8 can be applied before inserting the substrate 7 into the compression mold 1 by the aforementioned method. Alternatively, the electrode 8 can be processed in the same way as the electrolyte 9. In this case, a layer of the ceramic powder for the electrode 8 and a sintering additive is added after the substrate 7 has been inserted and then a layer of the powder for the electrolyte 9 and a sintering additive is added. If the electrode 8 is already present on the upper side of the substrate 7, filling in the ceramic powder for the electrode 8 is omitted. The opening of the interior 3 is closed again by the plunger 4. The interior 3 is brought to a temperature of 100° C. to 600° C. by the heating device 6. Once the interior 3 has been brought to a temperature of 100° C. to 600° C., plunger 4 is moved towards the interior 3 at a pressure of 50 to 500 MPa in order to press the materials 7 and 8 and 9 which have been brought into the interior. If necessary, the base 5 can be moved into the interior 3 in the same way. FIG. 3 shows the pressed state.

Following the pressing, a separate electrode layer 10 can be applied to the electrolyte layer 9 using aforementioned methods. After pressing and applying the electrode layer 10, an electrode-electrolyte unit 11 shown in FIG. 3 has been produced.

The electrolyte unit 11 may be part of a fuel cell, as outlined in FIG. 4. Fuel such as hydrogen, i.e., H₂, is supplied to the metal substrate 7. The hydrogen passes through the pores of the porous metal substrate 7 to the electrode layer 8. Under the release of electrons e⁻, protons, i.e., H+, are formed from the hydrogen at the anode 8, which then pass through the electrolyte 9 and thus reach the electrode 10. As shown, the electrons e flow via an electrical conductor and an electrical consumer from the metallic substrate 7 to the electrode 10, which is therefore a cathode of the fuel cell. The electrode layer 8 on the metallic substrate 7 is therefore the anode of the fuel cell. The electrode layer 8 can optionally be omitted if the substrate is made of the anode material (e.g., a ceramic-metal composite material such as BZCY-Ni).

At the cathode 10, water, i.e., H₂O, is formed from the protons, added oxygen, i.e., added O₂, and the electrons e⁻.

The electrolyte unit 11 may be part of an electrolysis cell, as outlined in FIG. 5. A voltage source is applied to the two electrodes 8 and 10 in such a way that electrons flow from the electrode 10 via the metal substrate 7 to the porous, gas-permeable electrode 8. Electrode 8 is then the cathode and electrode 10 is the anode of the electrolysis cell. Water is supplied to electrode 10. Oxygen is produced from the supplied water under the release of protons. The protons pass through the electrolyte layer 9 and recombine on the cathode side to form hydrogen by accepting electrons. The electrode layer 8 can optionally be omitted if the substrate is made of the electrode material (e.g., a ceramic-metal composite such as BZCY-Ni).

1. A method for producing a component having a gas-tight, ion-conducting ceramic functional layer, namely a ceramic electrolyte or a mixed-conducting gas separation membrane, comprising the steps of:
ceramic powder material is pressed with a sintering additive by a pressing tool at a pressure of at least 50 MPa and a temperature of at least 100° C.,
the pressed ceramic powder material and the sintering additive are sintered, wherein the sintering additive is a liquid sintering additive selected from water, a water-based solution with a defined pH, organic solvents and/or a ceramic precursor with metal nitrates, with metal citrates, with metal citrate complexes or with metal alcoholates or that the sintering additive is a powder comprising a hydroxide as a functional group,
wherein the ceramic powder material is pressed together with the sintering additive such that a density of 80% of the theoretical density is reached.

2. The method of claim 1, wherein a gas-permeable substrate is introduced into the pressing tool, after which the ceramic powder material and the sintering additive are introduced into the pressing tool onto of the gas-permeable substrate, and the gas-permeable substrate with the ceramic powder material and the sintering additive on it is pressed.

3. The method of claim 2, wherein the gas-permeable substrate consists of metal.

4. The method of claim 3, wherein the gas-permeable substrate consisting of metal comprises an electrode at the upper side.

5. The method of claim 2, wherein the gas-permeable substrate consists of an electrode material.

6. The method of claim 1, sintering is carried out at temperatures of less than 1400° C. or less than 1350° C. or not more than 1300° C. and/or at temperatures of more than 600° C.

7. The method of claim 5, wherein an electrode is applied to the functional layer after sintering.

8. The method of claim 7, wherein after applying the electrode, sintering is carried out at a temperature which is lower than the temperature at which sintering was previously carried out.

9. The method of claim 1, wherein the sintering additive is brought into the pressing tool in liquid form.

10. The method of claim 9, wherein a ceramic precursor is brought into the pressing tool.

11. The method of claim 1, wherein the sintering additive is selected from: water, a water-based solution with a defined pH value, organic solvents and/or that the ceramic precursor is selected from dissolved metal nitrates, metal citrates and metal alkoxylates.

12. The method of claim 1, wherein the ceramic powder material is pre-pressed, the sintering additive is added to the pre-pressed ceramic powder material and subsequently the pre-pressed sintered material is pressed together with a substrate.

13. The method of claim 12, wherein pre-pressing is carried out at a pressure of less than 500 MPa and/or more than 50 MPa.

14. The method of claim 1, wherein pressing is carried out at temperatures of not more than 600° C.

15. The method of claim 1, wherein pressing is carried out at a pressure of less than 500 MPa.

16. Component producible according to claim 1, wherein the sintering additive is completely converted into the ceramic or removed without residue after sintering.

17. The method of claim 6, wherein an electrode is applied to the functional layer after sintering.

18. The method of claim 12, wherein pre-pressing is carried out at a pressure of less than 500 MPa and more than 50 MPa.

19. The method of claim 13, wherein pressing is carried out at temperatures of not more than 600° C.

20. The method of claim 1, wherein pressing is carried out at a pressure of less than 500 MPa.
